(19) United States
(12) Patent Application Publication
(10) Pub. No.: US 2005/0058330 A1
(43) Pub. Date: Mar. 17, 2005

(54) Method of displaying smear image and retrieving method employing the same, surveillance method, system of displaying smear image, program for displaying smear image and recording medium recording the program

(75) Inventors: Takayuki Mitsuhashi, Sagamihara-shi (JP); Kiyoaki Watanabe, Tokyo (JP); Yohko Kawai, Tokyo (JP); Takeyoshi Fujiwara, Miki-shi (JP); Yoichi Sumida, Tokyo (JP); Takuma Watanabe, Tokyo (JP)

Correspondence Address: BRINKS HOFER GILSON & LIONE, P.O. BOX 10395, CHICAGO, IL, 60610, US

(73) Assignee: Sysmex Corporation

(21) Appl. No.: 10/942,343

(22) Filed: Sep. 16, 2004

(30) Foreign Application Priority Data
Sep. 16, 2003 (JP) JP2003-322482

(51) Int. Cl. G06F 17/60; G06K 9/00

(52) U.S. Cl. 382/128; 705/2

(57) ABSTRACT

A method of displaying a smear image capable of reducing a time required for displaying the smear image on a user terminal is provided. This method of displaying a smear image comprises steps of acquiring a prescribed partial image necessary for display, included in a plurality of partial images obtained by dividing the smear image and stored in a first database of an image server, from the image server through a communication network and displaying the prescribed partial image and acquiring another partial image required for display due to display scrolling on the terminal from the image server through the communication network and displaying the partial image in response to the display scrolling.

This application claims priority under 35 U.S.C. § 119 to Japanese Patent Application No. 2003-322482 filed Sep. 16, 2003, the entire content of which is hereby incorporated by reference.

### BACKGROUND

1. Field of the Invention

The present invention relates to a method of displaying a smear image and a retrieving method employing the same, a surveillance method, a system of displaying a smear image, a program for displaying a smear image and a recording medium recording this program, and more particularly, it relates to a method of displaying a smear image in a terminal receiving the smear image from an image server storing the smear image taken with a scale factor allowing recognition of a cell form through a communication network and displaying the smear image and a retrieving method employing the same, a surveillance method, a system of displaying a smear image, a program for displaying a smear image and a recording medium recording this program.

2. Description of the Background Art

A method of receiving a smear image taken with a scale factor allowing recognition of a cell form in a terminal from an image server storing the smear image through a communication network and displaying the smear image on the terminal is known in general, as disclosed in International Patent Laying-Open No. WO98/39728, for example.

The aforementioned International Patent Laying-Open No. WO98/39728 discloses a method of capturing a plurality of low scale factor images (1.25 magnifications) of a sample through a computer-controlled microscope and pasting these low scale factor images together for creating a macro image while capturing a plurality of high scale factor images (4, 20 and 40 magnifications) and pasting these high scale factor images together for creating a micro image. The International Patent Laying-Open No. WO98/39728 also discloses a technique of downloading the macro and micro images to a user terminal and displaying the same.

According to the conventional method of displaying smear images disclosed in the aforementioned International Patent Laying-Open No. WO98/39728, however, the user terminal can conceivably display the smear images (macro and micro images) thereon after downloading all partial images (low and high scale factor images) constituting the smear images, although this is not clearly described. In the conventional method of displaying smear images disclosed in the aforementioned International Patent Laying-Open No. WO98/39728, therefore, the user terminal disadvantageously requires a long time for displaying the smear images thereon. Further, the aforementioned International Patent Laying-Open No. WO98/39728 is directed to only an image of about 40 magnifications at the maximum. In a conventional blood test, however, an objective lens having oil immersion of 100 magnifications is generally used for observing a blood, leading to requirement for a high scale factor blood cell image of about 100 magnifications. When the method according to the aforementioned International Patent Laying-Open No. WO98/39728 is applied to such a blood cell image for displaying high scale factor partial images of about 100 magnifications on the user terminal, the user terminal must download a lager number of partial images, to disadvantageously require a longer time for displaying the smear images thereon.

### BRIEF SUMMARY

An object of the present invention is to provide a method and a system of displaying a smear image capable of reducing a time for displaying a smear image on a user terminal.

In order to attain the aforementioned object, a method of displaying a smear image according to a first aspect of the present invention is a method of displaying a smear image in a terminal receiving the smear image taken with a scale factor allowing recognition of a cell form from an image server including a first database storing the smear image through a communication network and displaying the smear image, comprising steps of acquiring a prescribed partial image necessary for display, included in a plurality of partial images obtained by dividing the smear image and stored in the first database of the image server, from the image server through the communication network and displaying the prescribed partial image and acquiring another partial image required for display due to display scrolling on the terminal from the image server through the communication network and displaying the partial image in response to the display scrolling.

In the method of displaying a smear image according to the first aspect, as hereinabove described, the prescribed partial image necessary for display included in the plurality of partial images obtained by dividing the smear image is acquired from the image server through the communication network and displayed so that only the prescribed partial image necessary for display may be acquired from the image server through the communication network and displayed, whereby the time for displaying the smear image (partial image) on a user terminal can be reduced as compared with a case of acquiring all partial images in the user terminal and thereafter displaying the prescribed partial image necessary for display. Further, the partial image required for display due to the display scrolling on the terminal is acquired from the image server through the communication network in response to the display scrolling, whereby only the partial image required for display due to the display scrolling may be acquired from the image server through the communication network and displayed also in the display scrolling. Thus, the time for displaying the smear image (partial image) on the user terminal can be reduced as compared with a case of acquiring all partial images in the user terminal and thereafter displaying the partial image required for display due to the display scrolling in response to the display scrolling. Further, the prescribed partial image necessary for display included in the plurality of partial images obtained by dividing the smear image is acquired from the image server through the communication network and displayed so that the user terminal may not receive large-sized image data at once but may receive only image data of the partial image necessary for display, whereby the communication time can be inhibited from increase also in a case of a high scale factor image of about 100 magnifications. Thus, communication stress can be reduced. In addition, the partial image required for display due to the display scrolling on the terminal is acquired from the image server through the communication network and displayed in response to the display scrolling so that the user terminal may not receive large-sized image data at once but may receive only image data of the partial image required for display due to the display scrolling, whereby the communication time can be inhibited from increase. Thus, the display scrolling can be inhibited from delay resulting from a long communication time.

A smear image display program according to a second aspect of the present invention is a smear image display program for executing a method of displaying a smear image taken with a scale factor allowing recognition of a cell form in a terminal receiving the smear image from an image server including a first database recording the smear image through a communication network and displaying the smear image, comprising steps of acquiring a prescribed partial image necessary for display, included in a plurality of partial images obtained by dividing the smear image and stored in the first database of the image server, from the image server through the communication network and displaying the prescribed partial image and acquiring another partial image required for display due to display scrolling on the terminal from the image server through the communication network and displaying the partial image in response to the display scrolling.

In the program for displaying a smear image according to the second aspect, as hereinabove described, the prescribed partial image necessary for display included in the plurality of partial images obtained by dividing the smear image is acquired from the image server through the communication network and displayed so that only the prescribed partial image necessary for display may be acquired from the image server through the communication network and displayed, whereby the time required for displaying the smear image (partial image) on a user terminal can be reduced as compared with a case of acquiring all partial images in the user terminal and thereafter displaying the prescribed partial image necessary for display. Further, the partial image required due to the display scrolling on the terminal is acquired from the image server through the communication network and displayed in response to the display scrolling so that only the partial image required for display due to the display scrolling may be acquired from the image server through the communication network and displayed also in the display scrolling. Thus, the time required for displaying the smear image (partial image) on the user terminal can be reduced as compared with a case of acquiring all partial images in the user terminal and thereafter displaying the partial image required for display due to the display scrolling. In addition, the prescribed partial image necessary for display included in the plurality of partial images obtained by dividing the smear image is acquired from the image server through the communication network and displayed so that the user terminal may not receive large-sized image data at once but may receive only the image data of the partial image necessary for display, whereby the communication time can be inhibited from increase also in a case of a high scale factor image of about 100 magnifications. Thus, communication stress can be reduced. Further, the partial image required for display due to the display scrolling on the terminal is acquired from the image server through the communication network and displayed in response to the display scrolling so that the user terminal may not receive large-sized image data at once but may receive only the image data of the partial image required for display due to the display scrolling also in the display scrolling, whereby the communication time can be inhibited from increase. Thus, the display scrolling can be inhibited from delay resulting from a long communication time.

A recording medium according to a third aspect of the present invention is a machine-readable recording medium recording a smear image display program for executing a method of displaying a smear image taken with a scale factor allowing recognition of a cell form in a terminal receiving the smear image from an image server including a first database recording the smear image through a communication network and displaying the smear image, comprising steps of acquiring a prescribed partial image necessary for display, included in a plurality of partial images obtained by dividing the smear image and stored in the first database of the image server, from the image server through the communication network and displaying the prescribed partial image and acquiring another partial image required for display due to display scrolling on the terminal from the image server through the communication network and displaying the partial image in response to the display scrolling. When employing the recording medium according to the third aspect, the aforementioned program for displaying a smear image can be easily run.

A method of sort-counting a cell according to a fourth aspect of the present invention is a method of sort-counting a cell on a screen displayed by a method of displaying a smear image comprising steps of acquiring a prescribed partial image necessary for display, included in a plurality of partial images obtained by dividing the smear image and stored in a first database of an image server, from the image server through a communication network and displaying the prescribed partial image and acquiring another partial image required for display due to display scrolling on a terminal from the image server through the communication network and displaying the partial image in response to the display scrolling, comprising steps of displaying a display screen including an image display part scrollably displaying the smear image received from the image server and a sort count display part for displaying a sort count value obtained by counting sort data of the cell and inputting the sort data by scrolling and observing the smear image displayed on the image display part.

In the method of sort-counting a cell according to the fourth aspect, as hereinabove described, the display screen including the image display part scrollably displaying a smear image corresponding to identification information received from the image server and the sort count display part for displaying the sort count value obtained by counting the sort data of the cell is displayed on the terminal while the smear image displayed on the image display part is scrolled and observed for inputting the sort data so that the smear image can be easily scrolled and observed for inputting the sort data on a display screen of a user terminal. According to the fourth aspect, further, a display method similar to the method of displaying a smear image according to the aforementioned first aspect is so employed that the time required for displaying the smear image on the user terminal by scrolling can be reduced. Thus, the cell can be further efficiently sort-counted.

A method of retrieving a smear image according to a fifth aspect of the present invention is a method of retrieving a smear image performed on a screen displayed by a method of displaying a smear image comprising steps of acquiring a prescribed partial image necessary for display, included in a plurality of partial images obtained by dividing the smear image and stored in a first database of an image server, from the image server through a communication network and displaying the prescribed partial image and acquiring another partial image required for display due to display scrolling on a terminal from the image server through the communication network and displaying the partial image in response to the display scrolling with the image server storing the smear image along with retrieval conditions, comprising steps of displaying a list of the smear image matching with the retrieval conditions in response to a retrieval result on the terminal as the retrieval result from the image server through the communication network and scrollably displaying a selected smear image in response to an operation of selecting a prescribed smear image in the list.

In the method of retrieving a smear image according to the fifth aspect, as hereinabove described, the terminal displays the list of the smear image matching with the retrieval conditions in response to the retrieval result as the retrieval result while scrollably displaying the selected smear image ip response to the operation of selecting the prescribed image in the list so that the smear image can be easily retrieved in a user terminal. According to the fifth aspect, further, a display method similar to the method of displaying a smear image according to the aforementioned first aspect is so employed that the time required for displaying the smear image on the user terminal by scrolling can be reduced. Thus, the smear image can be further efficiently retrieved. In addition, the user terminal may receive only image data of the partial image necessary for display by scrollably displaying the smear image by the method of displaying a smear image according to the first aspect, whereby the communication time can be inhibited from increase. Thus, communication stress can be reduced and the scrolling can be inhibited from delay when retrieving the smear image.

A surveillance method according to a sixth aspect of the present invention is a surveillance method for a smear image performed on a screen displayed by a method of displaying a smear image comprising steps of acquiring a prescribed partial image necessary for display, included in a plurality of partial images obtained by dividing the smear image and stored in a first database of an image server, from the image server through a communication network and displaying the prescribed partial image and acquiring another partial image required for display due to display scrolling on a terminal from the image server through the communication network and displaying the partial image in response to the display scrolling, comprising steps of displaying the smear image and a question related to the smear image on a specific web, receiving an answer to the question through the communication network, displaying a tabulation result of the answer on the web and scrollably displaying a selected smear image on the terminal in response to an operation of selecting the smear image displayed on the web.

In the surveillance method for a smear image according to the sixth aspect, as hereinabove described, the selected smear image is scrollably displayed on the terminal in response to the operation of selecting the smear image displayed on the web so that the smear image can be more detailedly studied when studying the question related to the smear image, whereby the question can be more correctly studied. According to the sixth aspect, further, a display method similar to the method of displaying a smear image according to the aforementioned first aspect is so employed that the time required for displaying the smear image on a user terminal by scrolling can be reduced. Thus, the smear image can be further efficiently surveyed. In addition, the user terminal may receive only image data of the partial image necessary for display by scrollably displaying the smear image by the method of displaying a smear image according to the first aspect, whereby the communication time can be inhibited from increase. Thus, communication stress can be reduced and the scrolling can be inhibited from delay when scrollably displaying the smear image in order to study the question related thereto.

A system of displaying a smear image according to a seventh aspect of the present invention is a system of displaying a smear image in a terminal receiving the smear image taken with a scale factor allowing recognition of a cell form from an image server including a first database storing the smear image through a communication network and displaying the smear image, comprising first display means acquiring a prescribed partial image necessary for display, included in a plurality of partial images obtained by dividing the smear image and stored in the first database of the image server, from the image server through the communication network and displaying the prescribed partial image and second display means acquiring another partial image required for display due to display scrolling on the terminal from the image server through the communication network and displaying the partial image in response to the display scrolling.

As hereinabove described, the system of displaying a smear image according to the seventh aspect is so provided with the first display means acquiring the prescribed partial image necessary for display, included in the plurality of partial images obtained by dividing the smear image and stored in the first database of the image server, from the image server through the communication network and displaying the same so that the system may acquire only the prescribed partial image necessary for display from the image server through the communication network and display the same, whereby the time required for displaying the smear image (partial image) on a user terminal can be reduced as compared with a case of acquiring all partial images in the user terminal and thereafter displaying the prescribed partial image necessary for display. Further, the system is so provided with the second display means acquiring the partial image required for display due to the display scrolling on the terminal from the image server through the communication network and displaying the same in response to the display scrolling that the system may acquire only the partial image required for display due to the display scrolling from the image server through the communication network and display the same also in the display scrolling. Thus, the time required for displaying the smear image (partial image) on the user terminal can be reduced as compared with a case of acquiring all partial images in the user terminal and thereafter displaying the partial image required for display due to the display scrolling. In addition, the system is so provided with the first display means acquiring the prescribed partial image necessary for display, included in the plurality of partial images obtained by dividing the smear image and stored in the first database of the image server, from the image server through the communication network and displaying the same that the user terminal may not receive large-sized image data at once but may receive only image data of the partial image necessary for display, whereby the communication time can be inhibited from increase also in a case of a high scale factor image of about 100 magnifications. Thus, communication stress can be reduced. Further, the system is so provided with the second display means acquiring the partial image required for display due to the display scrolling on the terminal from the image server through the communication network and displaying the same in response to the display scrolling that the system may not receive large-sized image data at once but may receive only image data of the partial image required for display due to the display scrolling also in the display scrolling, whereby the communication time can be inhibited from increase. Thus, the display scrolling can be inhibited from delay resulting from a long communication time.

A method of displaying a smear image according to an eighth aspect of the present invention is a method of displaying a smear image in a terminal receiving the smear image taken with a scale factor allowing recognition of a cell form from an image server including a first database storing the smear image through a communication network and displaying the smear image, comprising steps of acquiring a plurality of partial images, obtained by dividing the smear image and stored in the first database of the image server, from the image server through the communication network in prescribed order and displaying a prescribed partial image, necessary for display, included in the acquired partial images and preferentially acquiring another partial image required for display due to an operation for display on the terminal from the image server through the communication network and displaying the partial image in response to the operation when the partial image required for display is not acquired from the image server.

In the method of displaying a smear image according to the eighth aspect, as hereinabove described, the plurality of partial images obtained by dividing the smear image are acquired from the image server through the communication network in the prescribed order so that the prescribed partial image, necessary for display, included in the acquired partial images is displayed, whereby the prescribed partial image necessary for display can be displayed on a user terminal before acquiring all partial images in the user terminal. Thus, the time required for displaying the partial image on the user terminal can be reduced as compared with a case of acquiring all partial images in the user terminal and thereafter displaying the prescribed partial image necessary for display. Further, the partial image required for display due to the operation for display on the terminal is so preferentially acquired from the image server through the communication network and displayed that the partial image required for display due to the operation for display can be quickly displayed also in the operation for display on the terminal. Consequently, the time required for displaying the partial image on the user terminal can be reduced also in the operation for display on the terminal.

A system of displaying a smear image according to a ninth aspect of the present invention is a system of displaying a smear image in a terminal receiving the smear image taken with a scale factor allowing recognition of a cell form from an image server including a first database storing the smear image through a communication network and displaying the smear image, comprising first display means acquiring a plurality of partial images, obtained by dividing the smear image and stored in the first database of the image server, from the image server through the communication network in prescribed order and displaying a prescribed partial image, necessary for display, included in the acquired partial images and second display means preferentially acquiring another partial image required for display due to an operation for display on the terminal from the image server through the communication network and displaying the partial image in response to the operation when the partial image required for display is not acquired from the image server.

As hereinabove described, the system of displaying a smear image according to the ninth aspect is so provided with the first display means acquiring the plurality of partial images obtained by dividing the smear image from the image server through the communication network in the prescribed order while displaying the prescribed partial image necessary for display included in the acquired partial images that a user terminal can display the prescribed partial image necessary for display before acquiring all partial images therein. Thus, the time required for displaying the partial image on the user terminal can be reduced as compared with a case of acquiring all partial images in the user terminal and thereafter displaying the prescribed partial image necessary for display. Further, the system is so provided with the second display means preferentially acquiring the partial image required for display due to the operation for display on the terminal from the image server through the communication network and displaying the same in response to the operation for display when the partial image required for display is not acquired from the image server that the partial image required for display due to the operation for display can be quickly displayed also in the operation for display on the terminal. Consequently, the time required for displaying the partial image on the user terminal can be reduced also in the operation for display on the terminal.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates the overall structure of a system for implementing a method of displaying a virtual slide (blood cell image) according to a first embodiment of the present invention;

FIG. 2 is a schematic diagram for illustrating a method of creating a virtual slide (blood cell image) according to the first embodiment of the present invention;

FIG. 3 is a flow chart for illustrating an operation of creating a virtual slide (blood cell image) according to the first embodiment of the present invention;

FIG. 4 is a schematic diagram for illustrating a method of dividing and managing the virtual slide (blood cell image) according to the first embodiment of the present invention;

FIG. 5 is a flow chart for illustrating an operation of dividing the virtual slide (blood cell image) according to the first embodiment of the present invention;

FIG. 6 illustrates a display part of a client terminal employing the display method according to the first embodiment of the present invention;

FIG. 7 is a flow chart for illustrating an operation flow for the virtual slide (blood cell image) according to the first embodiment of the present invention;

FIG. 8 is a block diagram showing an exemplary operation network for making the best use of the virtual slide according to the first embodiment of the present invention;

FIG. 9 illustrates a survey problem screen for illustrating a surveillance method according to a second embodiment of the present invention;

FIG. 10 illustrates a test result screen displayed when clicking a test result tab on the survey problem screen shown in FIG. 9;

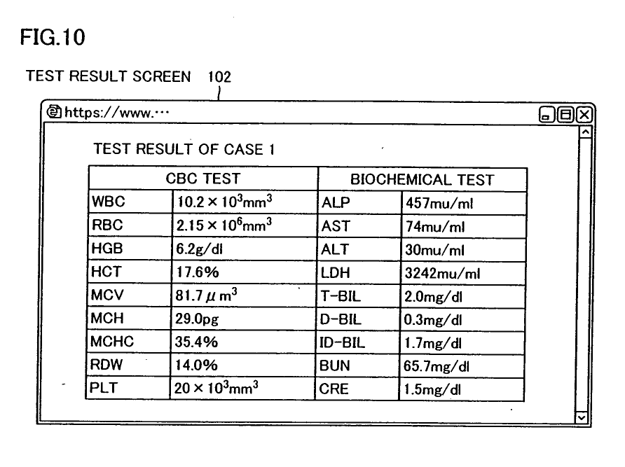

FIG. 11 illustrates a survey answer tabulation screen in the surveillance method according to the second embodiment of the present invention;

FIG. 12 is a schematic diagram for illustrating order for downloading partial images constituting a virtual slide of 20 magnifications in a method of downloading a virtual slide (blood cell image) according to a third embodiment of the present invention;

FIG. 13 is a flow chart for illustrating the method of downloading a virtual slide (blood cell image) according to the third embodiment of the present invention;

FIG. 14 is a flow chart for illustrating a subroutine for scale factor switching in the method of downloading a virtual slide (blood cell image) according to the third embodiment shown in FIG. 13; and

FIG. 15 is a flow chart for illustrating a subroutine for scrolling in the method of downloading a virtual slide (blood cell image) according to the third embodiment shown in FIG. 13.

### DETAILED DESCRIPTION OF THE DRAWINGS AND THE PRESENTLY PREFERRED EMBODIMENTS

Embodiments of the present invention are now described with reference to the drawings.

(First Embodiment)

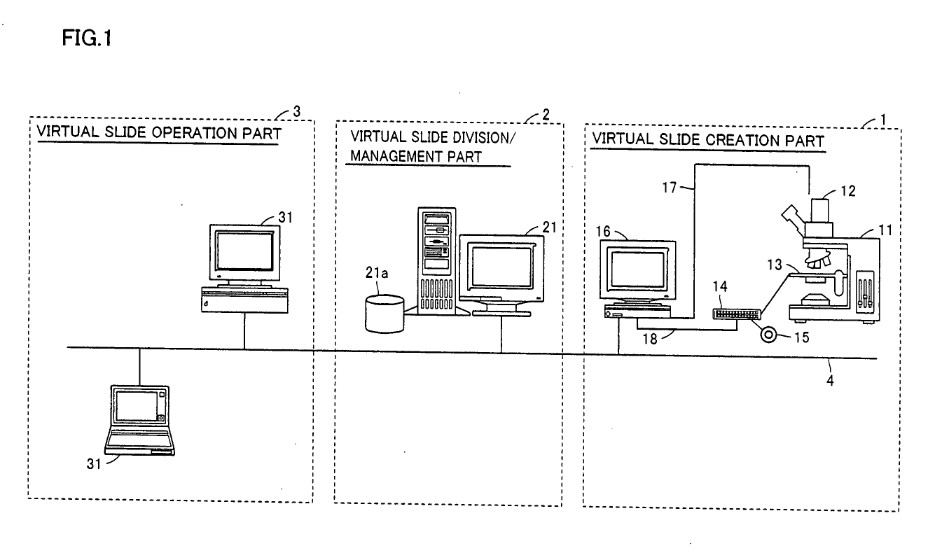

In a first embodiment of the present invention, a method of displaying a smear image according to the present invention is applied to a method of displaying a blood cell image. The overall structure of a system for implementing a method of displaying a virtual slide (blood cell image) according to the first embodiment of the present invention is now described with reference to FIG. 1.

As shown in FIG. 1, the system for implementing the method of displaying a virtual slide (blood cell image) according to the first embodiment is constituted of a virtual slide creation part 1, a virtual slide division/management part 2 and a virtual slide operation part 3. The virtual slide creation part 1 is provided with an optical microscope 11 having objective lenses of 20 and 100 magnifications for confirming sample slides, a 3CCD camera 12 for capturing images, an automatic stage 13 for position-controlling the optical microscope 11 in directions X, Y and Z, a control unit 14 and a joystick 15 for controlling the automatic stage 13, and an automatic stage control terminal 16 for controlling the automatic stage 11 while performing focus synthesis and image tiling. The optical microscope 11 is formed by BX-50 series by Olympus, for example, and the automatic stage 13 is formed by H101BX by PRIOR, for example. The 3CCD camera 12 is formed by KY-F70B by VICTOR, for example. The automatic stage control terminal 16 is connected to the 3CCD camera 12 and the control unit 14 through an image signal transmission cable 17 and a control unit control cable 18, respectively. The automatic stage control terminal 16 is connected to a LAN cable 4 serving as a network cable.

The virtual slide division/management part 2 is provided with a server 21 for managing virtual slide data and dividing images. The server 21 includes a database 21a for preserving the virtual slide data. This server 21 is connected to the LAN cable 4 serving as the network cable. The database 21a preserves the virtual slide data along with identification information such as specimen numbers. The database 21a also stores a table associating the identification information with attribute information. The attribute information includes patient attribute information such as the number, the name, the sex, the age and the blood type of each patient, the ward, the department of medical care, the name of his/her disease, his/her clinical recording, the doctor in charge and his/her diagnosis and observations, and specimen attribute information such as the date of a blood test, a request number, the date of collection, the type of a specimen and comments on the specimen. The virtual slide operation part 3 is provided with a client terminal 31 for evaluating and confirming virtual slides. This client terminal 31 is connected to the LAN cable 4 serving as the network cable.

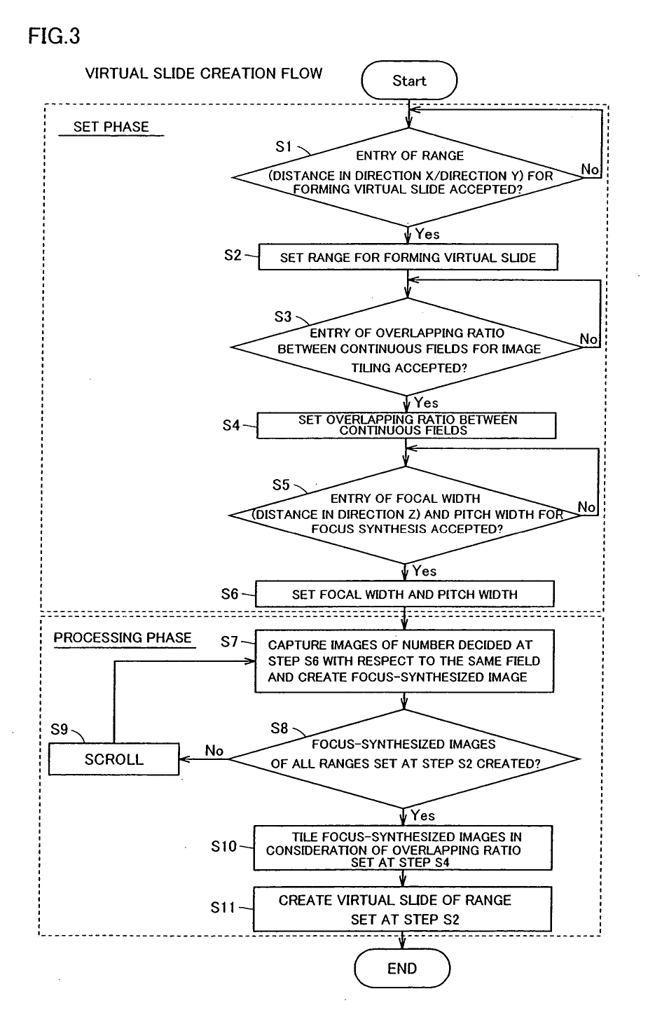

The method of creating a virtual slide (blood cell image) is now described with reference to FIGS. 1 to 3. The virtual slide creation part 1 shown in FIG. 1 creates the virtual slide (blood cell image). A creation flow for the virtual slide (blood cell image) is constituted of a set phase and a processing phase, as shown in FIG. 3. In the set phase, an operator sets a sample on the optical microscope 11 mounted with the automatic stage 13 (see FIG. 1). Then, the virtual slide creation part 1 determines whether or not the automatic stage control terminal 16 has accepted entry of a range (sample specimen area: distances in the directions X and Y) for forming the virtual slide at a step S1. When the virtual slide creation part 1 determines that the automatic stage control terminal 16 has accepted no entry of the range for forming the virtual slide at the step S1, the operator inputs the range for forming the virtual slide through an input unit of the automatic stage control terminal 16. Then, the virtual slide creation part 1 determining that the automatic stage control terminal 16 has accepted entry of the range for forming the virtual slide at the step S1 sets the range for forming the virtual slide with the automatic stage control terminal 16 at a step S2. Thereafter the virtual slide creation part 1 determines whether or not the automatic stage control terminal 16 has accepted entry of an overlapping ratio between continuous fields for image tiling at a step S3. When the virtual slide creation part 1 determines that the automatic stage control terminal 16 has accepted no entry of the overlapping ratio between the continuous fields for image tiling at the step S3, the operator inputs the overlapping ratio between the continuous fields for image tiling through the input unit of the automatic stage control terminal 16. The virtual slide creation part 1 determining that the automatic stage control terminal 16 has accepted entry of the overlapping ratio between the continuous fields for image tiling at the step S3 sets the overlapping ratio between the continuous fields for image tiling with the automatic stage control terminal 16 at a step S4. This overlapping ratio is preferably set to at least about 10% and not more than about 40%. Thereafter the virtual slide creation part 1 determines whether or not the automatic stage control terminal 16 has accepted entry of a focal width (distance in the direction Z) and a pitch width for focus synthesis at a step S5. When the virtual slide creation part 1 determines that the automatic stage control terminal 16 has accepted no entry of the focal width (distance in the direction Z) and the pitch width for focus synthesis at the step S5, the operator inputs the focal width and the pitch width through the input unit of the automatic stage control terminal 16. The virtual slide creation part 1 determining that the automatic stage control terminal 16 has accepted entry of the focal width and the pitch width for focus synthesis at the step S5 sets the focal width and the pitch width for focus synthesis with the automatic stage control terminal 16 at a step S6. The virtual slide creation part 1 decides the number of images captured in the same field by setting the focal width and the pitch width. According to the first embodiment, the focal width and the pitch width are set to not more than about 1 mm and about 0.1 μm respectively. The virtual slide creation part 1 completes the set phase of the flow for creating the virtual slide (blood cell image) through the processing of the aforementioned steps S1 to S6.

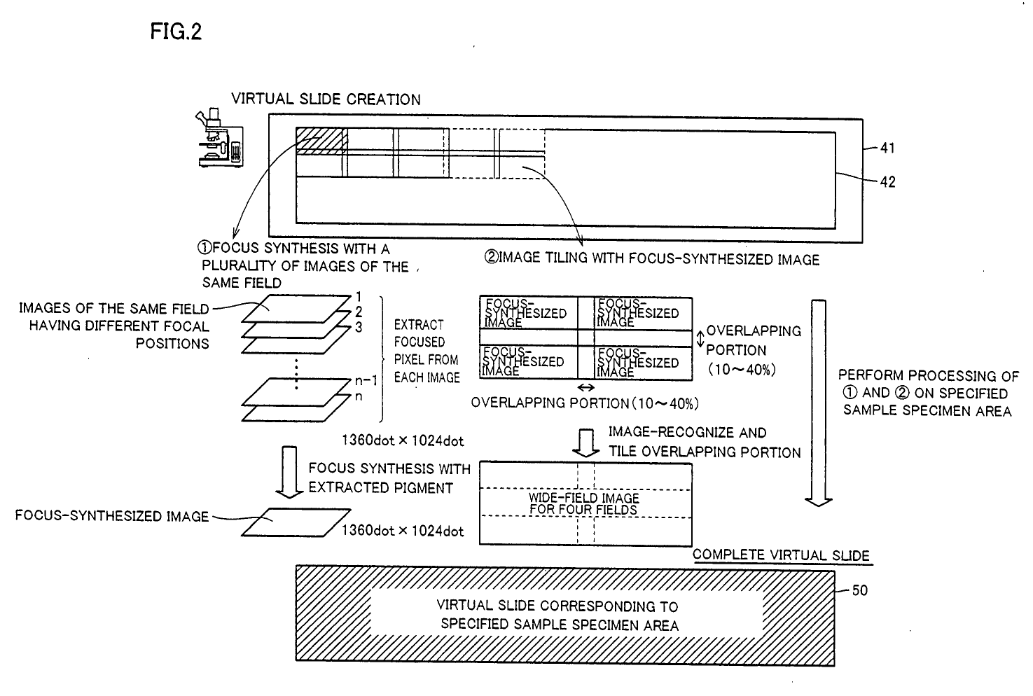

In the processing phase, the virtual slide creation part 1 captures images of the number decided at the step S6 for the same field into the automatic stage control terminal 16 with the 3CCD camera 12 and creates focus-synthetic images in the automatic stage control terminal 16 at a step S7. The term “focus synthesis” indicates processing of extracting focused pixels from each of images of the same field having different focal positions and creating an entirely focused image. According to the first embodiment, the virtual slide creation part 1 performs this focus synthesis on captured images of all fields thereby forming focus-synthetic images of a resolution of 1360 dots by 1024 dots, as shown in FIG. 2. The TIF format is employed for the focus-synthetic images. Thereafter the virtual slide creation part 1 determines whether or not focus-synthetic images of the total range set at the step S2 have been created at a step S8 shown in FIG. 3, for making scrolling at a step S9 and thereafter performing the focus synthesis at the step S7 again when determining that the focus-synthetic images have not been created. The virtual slide creation part 1 repeats this processing until the focus synthetic images of the total range set at the step S2 are created.

When determining that the focus synthetic images of the total range have been created at the step S8, the virtual slide creation part 1 image-tiles the focus-synthetic images at a step S10 with the automatic stage control terminal 16 in consideration of the overlapping ratio set at the step S4, as shown in FIG. 2. In this image tiling, the virtual slide creation part 1 image-recognizes overlapping portions of adjacent focus-synthetic images for pasting the focus-synthetic images together so that seams therebetween are inconspicuous. At a step S11, the virtual slide creation part 1 performs image tiling over the total range set at the step S2, thereby completing a virtual slide (blood cell image) 50 as shown in FIG. 2. The BMP format is employed for this virtual slide (blood cell image) 50. The size of the virtual slide 50 created at the step S11 is about 220,000 dots by 134,000 dots. The server 21 preserves this virtual slide (blood cell image) 50 created with the automatic stage control terminal 16 through the LAN cable 4.

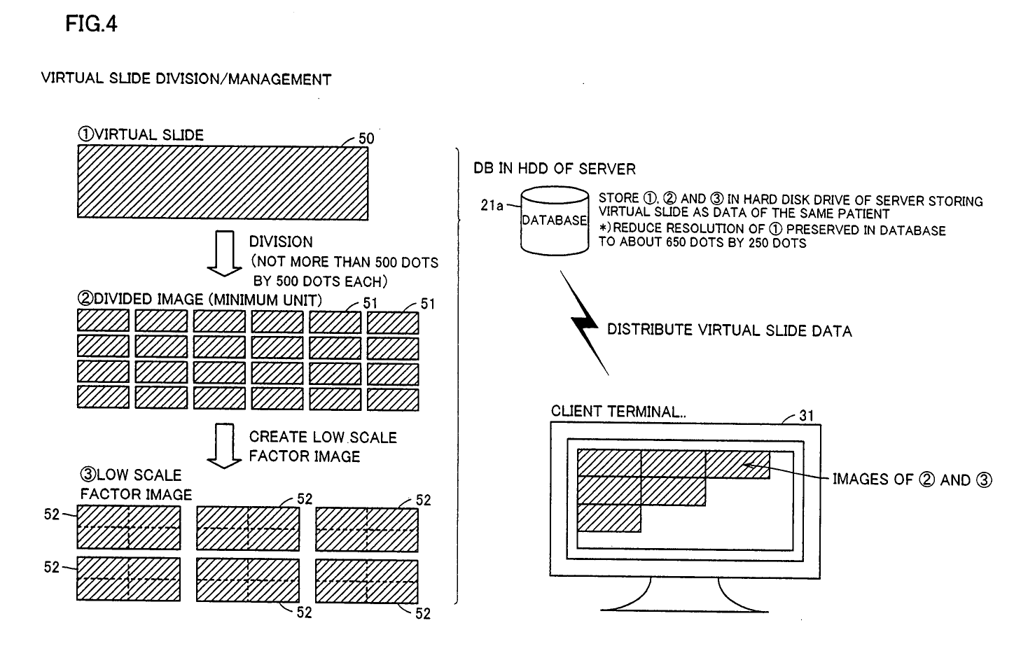

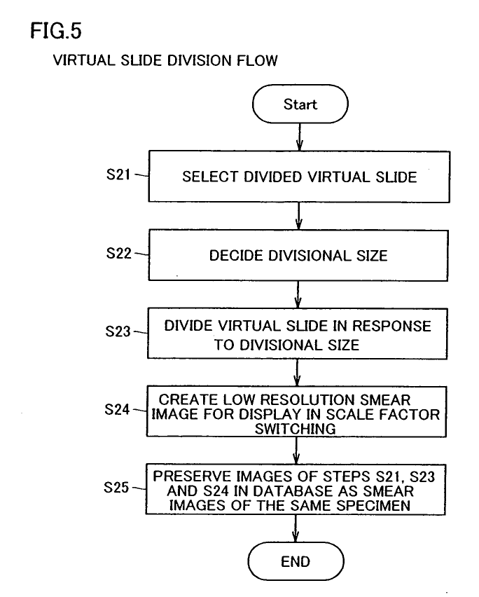

The server 21 of the virtual slide division/management part 2 shown in FIG. 1 divides and manages the vertical slide (blood cell image) 50. In order to divide the virtual slide (blood cell image) 50, the server 21 selects the virtual slide 50 to be divided from those preserved therein, each having the size of about 220,000 dots by 134,000 dots, at a step S21 shown in FIG. 5. The server 21 decides the divisional size at a step S22. According to the first embodiment, the server 21 divides the virtual slide 50 into divided images 51 of 500 dots by 500 dots, as shown in FIG. 4. The divisional size is preferably 10 dots by 10 dots to 700 dots by 700 dots, more preferably 100 dots by 100 dots to 500 dots by 500 dots. At a step S23, the server 21 divides the virtual slide 50 in response to the divisional size decided at the step S22, thereby creating the divided images 51 as shown in FIG. 4. The JPEG format (compressibility of about 10 in Photoshop Version 7.0.1) is employed for the divided images 51.

At a step S24, the server 21 creates low scale factor images 52 (see FIG. 4) as low resolution smear images to be displayed in scale factor switching. More specifically, the server 21 concatenates some (four in the first embodiment) divided images 51 with each other for creating each of wide-field images (low scale factor images 52). Then, the server 21 reduces the resolution of the created wide-field images (low scale factor images 52) thereby reducing the file size. For example, the server 21 creates low scale factor images 52 of 10 magnifications from a virtual slide 50 created with the objective lens of 20 magnifications of the optical microscope 11 while creating low scale factor images 52 of 40 and 60 magnifications from another virtual slide 50 created with the objective lens of 100 magnifications of the optical microscope 11 (see FIG. 1). The JPEG format (compressibility of about 10 in Photoshop Version 7.0.1) is employed for the low scale factor images 52.

At a subsequent step S25, the server 21 preserves the virtual slide 50, i.e., a total image, and the divided images 51 and the low scale factor images 52, i.e., partial images, created at the steps S21, S23 and S24 respectively in the database 21a shown in FIG. 1 as smear images of the same specimen (same patient) along with identification information of the specimen. In this case, the server 21 reduces the resolution of the virtual slide (blood cell image) 50 preserved in the database 21a as the total image to about 650 dots by 250 dots. A relational base is employed as the database 21a of the server 21 storing the virtual slide 50, the divided images 51 and the low scale factor images 52, for example.

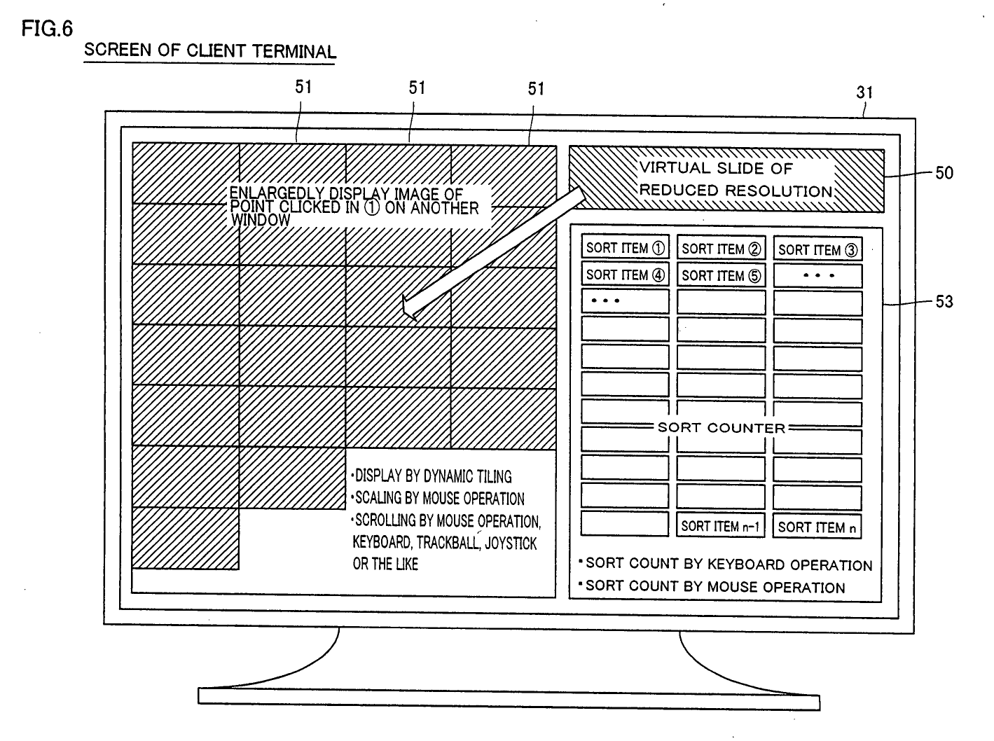

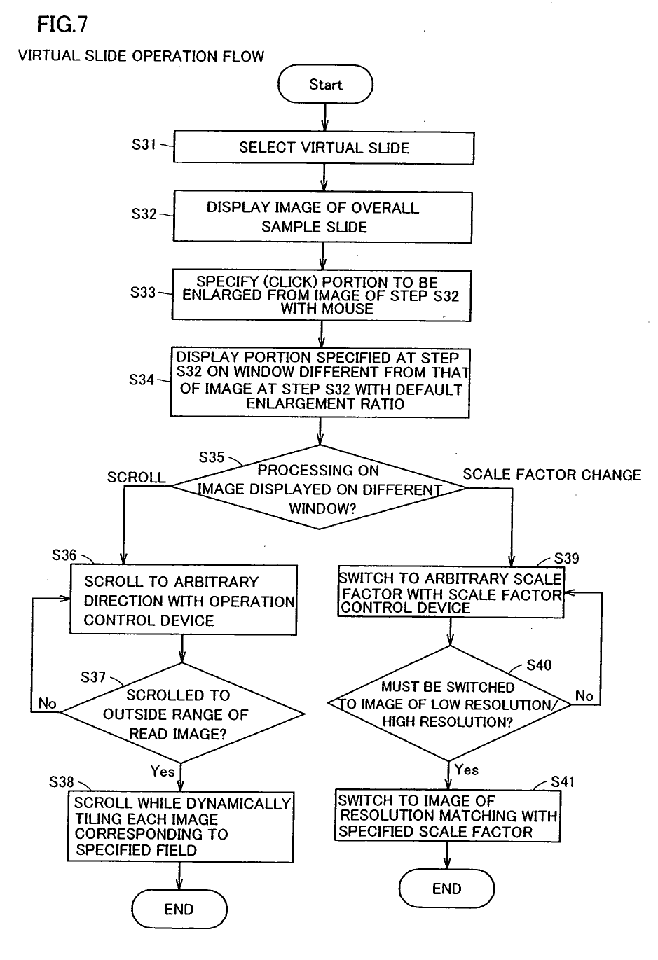

A method of operating the virtual slide (blood cell image) 50 according to the first embodiment is described with reference to FIGS. 1, 4 and 6 to 8. The client terminal 31 of the virtual slide operation part 3 shown in FIG. 1 operates this virtual slide (blood cell image) 50. At a step S31 shown in FIG. 7, the user selects the virtual slide (blood cell image) 50 in the client terminal 31. Thus, the server 21 distributes the image of the overall virtual slide 50 to the client terminal 31, which in turn displays the virtual slide 50 on the upper right portion of a display part thereof at a step S32, as shown in FIG. 6. At this step S32, the client terminal 31 displays the virtual slide (blood cell image) 50 of the low resolution of about 650 dots by 250 dots preserved at the step S25.

In order to display the virtual slide 50 and a partially enlarged image of the virtual slide 50 described later on the client terminal 31, a recording medium such as an FD or a CD storing a program for executing the method of displaying a virtual slide according to the first embodiment must be built into the client terminal 31 or the program must be installed into the client terminal 31 from the aforementioned recording medium.

At a step S33 shown in FIG. 7, the user specifies (clicks) a portion to be enlarged from the total image (virtual slide 50) displayed on the upper right portion of the screen at the step S32 with a mouse. Thus, the client terminal 31 displays the portion specified at the step S33 on a window (left window in FIG. 6) different from that of the total image displayed at the step S32 with a default scale factor at a step S34. At this time, the server 21 distributes only image data, necessary for displaying the enlarged image, included in the divided images 51 or the low scale factor images 52 constituting the virtual slide 50 to the client terminal 31. In this case, the client terminal 31 receives the divided images 51 or the low scale factor images 52 of a range slightly wider than that displayed on the screen (window) from the server 21.

According to the first embodiment, the client terminal 31 displays the enlarged image at the step S34 by dynamically tiling a plurality of divided images 51 or a plurality of low scale factor images 52. The term “dynamically tiling” indicates an operation of dynamically pasting individual images together on the screen of the client terminal 31. In this dynamic tiling, the client terminal 31 simply repastes the partial images (the divided images 51 or the low scale factor images 52) already tiled and thereafter divided in order to create the virtual slide 50 together, to result in no displacement between adjacent images 51 or 52. Therefore, the time for the dynamic tiling, requiring no image recognition dissimilarly to the image tiling for creating the virtual slide 50 at the step S10, can be reduced. Further, the client terminal 31 downloads only the partial images (the divided images 51 or the low scale factor images 52) necessary for displaying the enlarged image, whereby the communication time is inhibited from increase.

The default scale factor at the step S34 is rendered selectively settable. For example, the client terminal 31 selects the default scale factor from about 10, 20, 40, 60 and 100 magnifications. When selecting the 20 or 100 magnifications identically to either objective lens of the optical microscope 11 (see FIG. 1), the client terminal 31 receives and displays the high resolution divided images 51 of 20 or 100 magnifications created at the step S23. When selecting 10, 40 or 60 magnifications dissimilarly to the objective lenses of the optical microscope 11 (see FIG. 1), on the other hand, the client terminal 31 receives and displays the low resolution low scale factor images 52 of 10, 40 or 60 magnifications created at the step S24.

At a step S35 shown in FIG. 7, the client terminal 31 determines whether to perform scrolling or scale factor changing as processing on the enlarged image displayed on the different window. When performing scrolling, the terminal 31 makes scrolling in an arbitrary direction with an operation control device such as the mouse, a keyboard, a trackball or a joystick at a step S36. At a step S37, the client terminal 31 determines whether or not the same has made scrolling out of the image range read at the step S34. When determining that the same has not made scrolling out of the image range read at the step S34 at the step S37, the client terminal 31 returns to the step S36. When determining that the same has made scrolling out of the image range at the step S34 at the step S37, on the other hand, the client terminal 31 accesses the database 21a of the server 21 at a step S38 for capturing individual partial images (the divided images 51 or the low scale factor images 52) corresponding to a field newly required for display due to the scrolling from the server 21 through the LAN cable 4. Also in this case, the client terminal 31 receives the divided images 51 or the low scale factor images 52 of a range slightly wider than that displayed on the screen (window) from the sever 21. The client terminal 31 makes scrolling along with dynamic tiling.

When determining to perform scale factor changing at the step S35, on the other hand, the client terminal 31 switches the scale factor to an arbitrary level by a scale factor control device such as a button of the mouse, the keyboard or a button of the trackball at a step S39. According to the first embodiment, the client terminal 31 displaying image data of the partially enlarged image of the virtual slide (blood cell image) 50 can zoom (scale) the image to an arbitrary scale factor not present in the actual optical microscope 11 (see FIG. 1). The client terminal 31 determines whether or not it is necessary to switch the image to that of a low/high resolution at a step S40, and returns to the step S39 if determining that it is not necessary to switch the image at the step S40. If determining that it is necessary to switch the image at the step S40, on the other hand, the client terminal 31 switches the image to that of a resolution matching with the specified scale factor at a step S41. For example, the client terminal 31 zooms out the images (divided images 51) of 100 magnifications and switches the same to the low resolution low scale factor images 52 of 40 magnifications when the scale factor reaches 40 magnifications. At the steps S31, S32, S34, S38 and S41, the database 21a of the server 21 preserving the virtual slide 50 transmits information such as specimen information related to the image to the client terminal 31. Thus, it is possible to combinedly perform scrolling and scale factor changing thereby enlarging and observing a desired cell found by scrolling, reducing the cell after completing the observation and performing scrolling for searching for another desired cell.

According to the first embodiment, as hereinabove described, the client terminal 31 may simply acquire only partial images necessary for display, included in the partial images preserved in the database 21a of the server 21, from the server 21 through the LAN cable 4 and display the same, whereby the time required for displaying the partial images on the window of the client terminal 31 can be reduced as compared with a case of acquiring all partial images and thereafter displaying those necessary for display on the window of the client terminal 31. Further, the client terminal 31 acquires the partial images required for display due to display scrolling on the client terminal 31 from the server 21 through the LAN cable 4 and displays the same in response to the display scrolling so that only the partial images necessary for display may be acquired from the server 21 through the LAN cable 4 and displayed also in the scrolling. Thus, the time required for displaying the partial images on the window of the client terminal 31 can be reduced as compared with the case of acquiring all partial images in the client terminal 31 and thereafter displaying those necessary for display on the window of the client terminal 31.

According to the first embodiment, the client terminal 31 acquires only partial images (the divided images 51 or the low scale factor images 52), necessary for display on the client terminal 31, included in the partial images (the divided images 51 or the low scale factor images 52) preserved in the database 21a of the server 21 from the server 21 through the LAN cable 4 so that the client terminal 31 may not receive large-sized image data at once but may simply receive only the image data of the partial images (the divided images 51 or the low scale factor images 52) necessary for display, whereby the communication time can be inhibited from increase also for a blood cell image requiring a high scale factor of about 100 magnifications. Thus, communication stress can be reduced. Further, the client terminal 31 acquiring the partial images required for display due to display scrolling on the client terminal 31 from the server 21 through the LAN cable 4 and displaying the same in response to the display scrolling may not receive large-sized image data at once but may receive only the image data of the partial images (the divided images 51 or the low scale factor images 52) necessary for display also in the scrolling, whereby the scrolling can be inhibited from delay resulting from a long communication time.

According to the first embodiment, the virtual slide creation part 1 employs image tiling for creating the virtual slide 50 so that a plurality of partial area images can be easily pasted together also for the high scale factor blood cell image of about 100 magnifications. In addition, the virtual slide creation part 1 employs the images obtained by focus-synthesizing a plurality of images taken on different focal positions as to the same area for performing image tiling, so that the same can easily create a totally focused single image by pasting the plurality of partial area images together by image tiling.

According to the first embodiment, the client terminal 31 acquires the partial images (the divided images 51 or the low scale factor images 52) of the range slightly wider than that for displaying the partial images (the divided images 51 or the low scale factor images 52) from the server 21 through the LAN cable 4 for acquiring the prescribed partial images (the divided images 51 or the low scale factor images 52) necessary for display from the server 21 through the LAN cable 4 so that the same may simply display already acquired partial images (the divided images 51 or the low scale factor images 52) without acquiring new partial images (the divided images 51 or the low scale factor images 52) from the server 21 through the LAN cable 4 when slightly performing scrolling while displaying the prescribed partial images (the divided images 51 or the low scale factor images 52), whereby the scrolling can be more smoothly performed.

According to the first embodiment, the client terminal 31 acquires the partial images (the divided images 51 or the low scale factor images 52) of the range slightly wider than that for displaying the partial images (the divided images 51 or the low scale factor images 52) required for display due to scrolling from the server 21 through the LAN cable 4 for acquiring the partial images (the divided images 51 or the low scale factor images 52) required for display due to scrolling from the server 21 through the LAN cable 4 so that the same may simply display the partial images (the divided images 51 or the low scale factor images 52) acquired in precedent scrolling without acquiring new partial images (the divided images 51 or the low scale factor images 52) from the server 21 through the LAN cable 4 when further slightly performing scrolling after the scrolling, whereby the scrolling can be more smoothly performed.

According to the first embodiment, as hereinabove described, the client terminal 31 capable of zooming the blood cell image to an arbitrary scale factor can zoom (scale) the blood cell image also to a scale factor not provided in the actual optical microscope 11, whereby the blood cell image can be observed in a more proper size.

According to the first embodiment, the server 21 creates the high resolution divided images 51 and the low resolution low scale factor images 52 while zooming out (reducing) the high resolution divided images 51 and switching the same to the low scale factor images 52 when reaching the scale factor of the low scale factor images 52, whereby the communication time can be further reduced and the scrolling can be more quickly performed due to the data quantity of the low scale factor images 52 smaller than that of the divided images 51.

A sort-counting method employing the method of displaying a virtual slide according to the first embodiment is now described with reference to FIG. 6. In a test of blood cells, a sort counter generally sort-counts erythrocytes or the like present in a prescribed area. As shown in FIG. 6, a sort counter display part (window) 53 is provided on the right side of the display part of the client terminal 31, while an image display part (window) displaying the cell image in an enlarged manner is provided on the left side of the screen. In order to perform sort counting, the user observes the divided images 51 (or the low scale factor images 52) displayed on the image display part while scrolling the screen and selects sort items of the cell image with the mouse or the keyboard, thereby inputting sort data (performing sort counting).

When finding an abnormal cell during sort counting according to the first embodiment, the user specifies the abnormal cell with the mouse or the like and inputs the sort items so that the database 21a (see FIG. 1) of the server 21 stores the image including the abnormal cell and the attribute information of the specimen employed for creating the image through the LAN cable 4 in entry of the sort data (sort items). Alternatively, the program may automatically find the abnormal cell through image recognition for moving a cursor to the position of the abnormal cell and input sort items in this state so that the database 21a of the server 21 stores the image including the abnormal cell and the attribute information of the specimen employed for creating the image through the LAN cable 4 in entry of the sort data (sort items).

In the sort-counting method according to the first embodiment, the user can count the sort data by observing the blood cell image while scrolling the same, so that the sort data can be easily input. When the abnormal cell is found, the image including the abnormal cell and the attribute information of the specimen employed for creating the image can be preserved in the database 21a of the server 21 through the LAN cable 4, whereby an operation of capturing the image of the abnormal cell can be simplified.

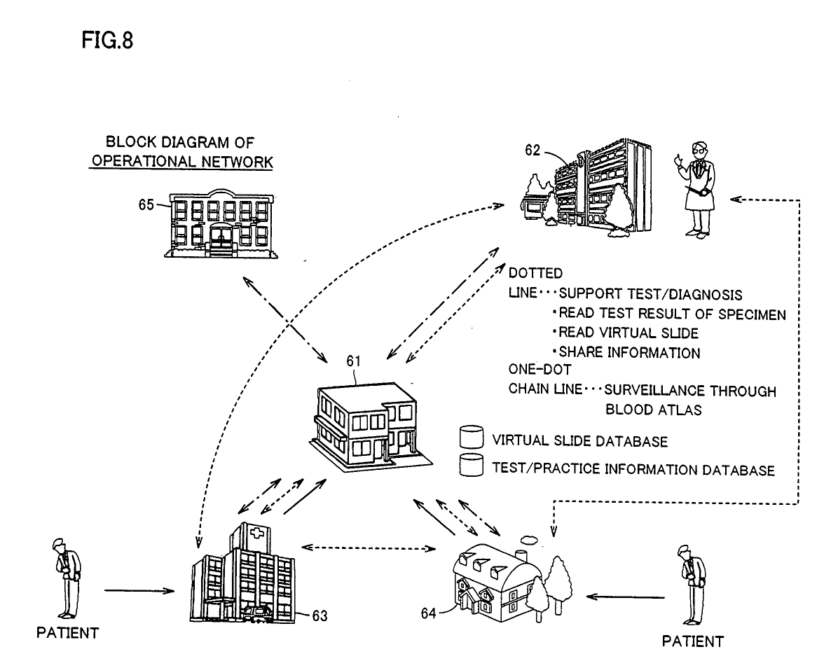

An exemplary operational network for creating, preserving and managing virtual slide data in an out-hospital facility is now described with reference to FIG. 8. The operational network shown in FIG. 8 is constituted of a medical facility 61 such as a test center, a large-scale facility 62 such as a specific function hospital, a community support hospital 63 such as a preferential or municipal hospital, a small-scale facility 64 such as a practitioner's hospital or clinic and an educational facility 65 such as a clinical examiner special school. In a flow of the operational network, a patient visiting the community support hospital 63 or the small-scale facility 64 is subjected to specimen collection such as blood collection or urine collection. Then, the specimen is transported to the medical facility 61 such as a test center. The medical facility 61 tests the specimen and creates, preserves and manages a virtual slide as to this specimen. Therefore, the medical facility 61 corresponds to the virtual slide creation part 1 and the virtual slide division/management part 2 shown in FIG. 1. A test/medical information database storing results of specimen tests etc. and a virtual slide database storing virtual slides are set in the medical facility 61.

Any user in the large-scale facility 62, the community support hospital 63 or the small-scale facility 64 can read the specimen test results and the virtual slides preserved in the test/medical information database and the virtual slide database of the medical facility 61 respectively through the network. In other words, the client terminal 31 according to the first embodiment is set in each of the large-scale facility 62, the community support hospital 63 and the small-scale facility 64 so that the user can read the virtual slides and the specimen test results through the client terminal 31. Also in a case of performing cell retrieval or surveillance through a blood atlas (blood sample pictorial image guide formed by keyword-retrievable virtual slides), the large-scale facility 62, the community support hospital 63, the small-scale facility 64 and the educational facility 65 can exchange information with the medical facility 61 through the network.

When virtual slides are created, preserved and managed in the same hospital clinic and test departments in this hospital can be linked with each other for attaining efficient operation.

(Second Embodiment)

A surveillance method according to a second embodiment of the present invention is now described.

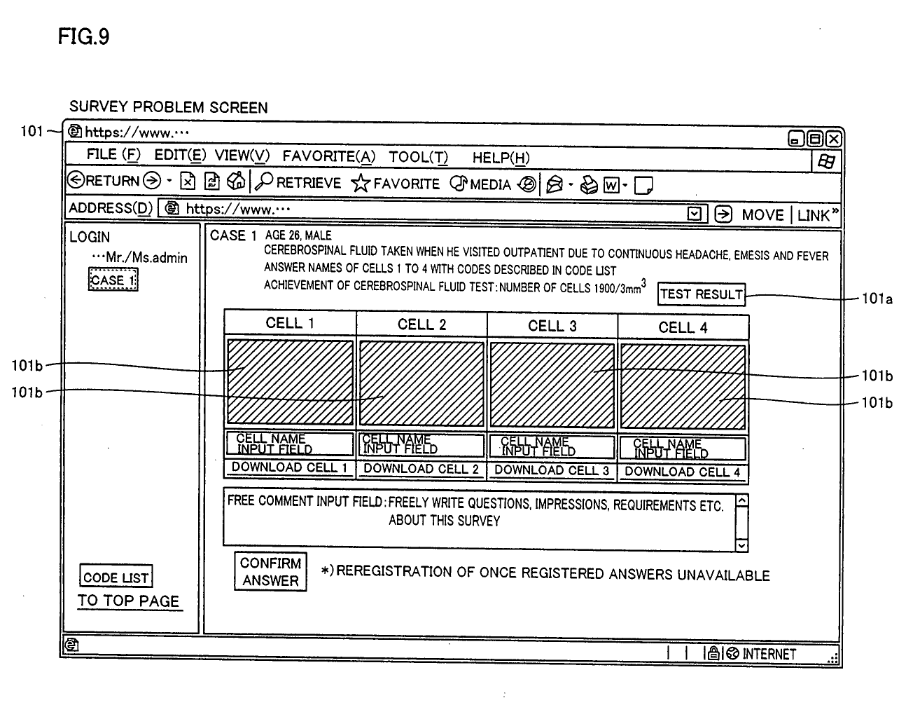

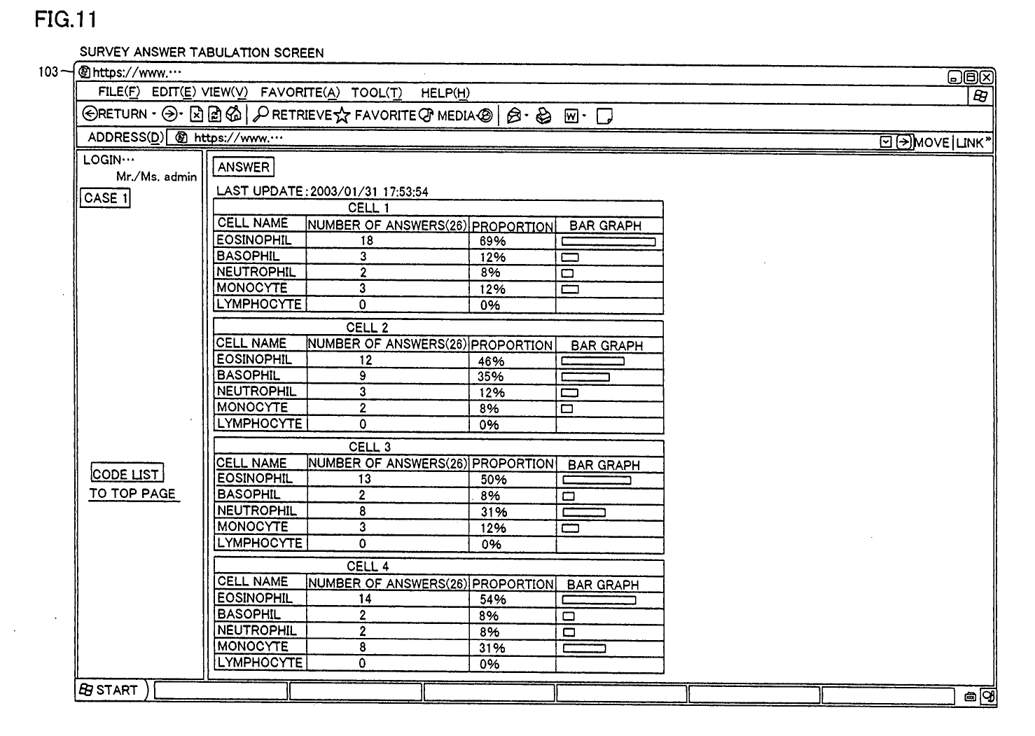

According to the second embodiment, the method of displaying the virtual slide image on the client terminal 31 according to the aforementioned first embodiment is applied to the surveillance method. More specifically, a survey problem screen shown in FIG. 9 displays cerebrospinal fluid cell images (virtual slides) 101b and questions related to the cerebrospinal fluid cell images 101b on a specific web. Referring to FIG. 9, the survey problem screen displays four cerebrospinal fluid cell images 101b of the same patient. When the user clicks a test result tab 110a on the survey problem screen shown in FIG. 9, a test result screen 102 is displayed as shown in FIG. 11. FIG. 11 shows a tabulation result screen 103 of answers to the survey questions shown in FIG. 9.

When the user clicks any of the four cerebrospinal fluid cell images (virtual slides) 101b displayed on the survey problem screen shown in FIG. 9 in the surveillance method according to the second embodiment, a virtual slide window of the client terminal 31 starts to display this cerebrospinal fluid cell image (virtual slide) 101b to be scrollable and changeable to an arbitrary scale factor.

In the surveillance method according to the second embodiment, as hereinabove described, the client terminal 31 displays the selected cerebrospinal fluid cell image (virtual slide) 101b to be scrollable in response to the operation of selecting any of the cerebrospinal fluid cell images (virtual slides) 101b displayed on the web so that the user can more detailedly study the selected cerebrospinal fluid cell image (virtual slide) 101b when studying the questions related to the cerebrospinal fluid cell image (virtual slide) 101b, whereby trailing can be made with a sense close to actual test/diagnosis operation for easily reflecting the results of training on actual operation. In the surveillance method according to the second embodiment, further, a display method similar to that according to the aforementioned first embodiment is so employed that a time required for displaying a blood cell image on the client terminal 31 by scrolling can be reduced. Thus, the blood cell image can be more efficiently surveyed. In addition, the client terminal 31 so displays the cerebrospinal fluid cell images (virtual slides) 101b to be scrollable in the display method similar to that according to the first embodiment that the same may receive only image data of partial images necessary for display from a server, whereby a communication time can be inhibited from increase. When displaying the cerebrospinal fluid cell images (virtual slides) 101b to be scrollable in order to study the questions related thereto, therefore, communication stress can be reduced and the scrolling can be inhibited from delay.

As a modification of the second embodiment, the method of displaying a virtual slide according to the first embodiment may be applied not to a surveillance method but to a method of retrieving a blood cell image from a blood atlas. In this case, the server 21 stores virtual slides (blood cell images) along with retrieval conditions so that the client terminal 31 displays a list of virtual slides (blood cell images) matching with retrieval conditions in response to retrieval results as the retrieval results. Then, the client terminal 31 displays a selected blood cell image to be scrollable and changeable to an arbitrary scale factor in response to an operation of selecting a prescribed blood cell image from the list.

In a method of retrieving a smear image (virtual slide) according to the modification of the second embodiment of the present invention, as hereinabove described, the client terminal 31 displays the list of the blood cell images (virtual slides) matching with the retrieval conditions in response to retrieval results as the retrieval results while displaying the selected blood cell image to be scrollable in response to the operation of selecting the prescribed blood cell image from the list, whereby the user can easily retrieve the blood cell image on the client terminal 31. In the method of retrieving a smear image according to the modification of the second embodiment, further, the display method similar to that according to the aforementioned first embodiment is so employed that the time required for displaying the blood cell image on the client terminal 31 by scrolling can be reduced. Thus, the blood cell image can be more efficiently retrieved. When displaying the blood cell image to be scrollable by the display method according to the first embodiment, the client terminal 31 may simply receive only image data of partial images necessary for display from the server 21, whereby the communication time can be inhibited from increase. Thus, communication stress can be reduced and the scrolling can be inhibited from delay when retrieving the blood cell image.

(Third Embodiment)

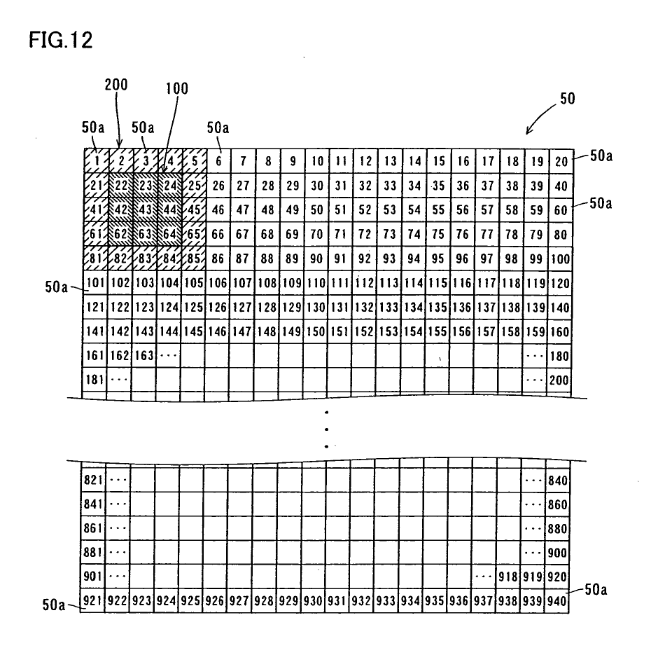

Referring to FIGS. 12 to 15, a method of downloading virtual slides (blood cell images) 50 according to a third embodiment of the present invention is different from the aforementioned first embodiment. The method of downloading virtual slides (blood cell images) 50 according to the third embodiment of the present invention is now described in detail.

According to the third embodiment, the virtual slides 50 of three scale factors, i.e., 20, 40 and 80 magnifications are downloaded. Each of the virtual slides of 20, 40 and 80 magnifications is constituted of a plurality of partial images and preserved in a database 21a of a server 21 (see FIG. 1). As to the partial images employed in the third embodiment, the virtual slide 50 of 20 magnifications may be constituted of a plurality of divided images created through an objective lens of 20 magnifications while the virtual slides 50 of 40 and 80 magnifications may be constituted of low scale factor images prepared by connecting a plurality of divided images created through an objective lens of 100 magnifications and reducing resolutions, or the virtual slides 50 of 20, 40 and 80 magnifications may be constituted of low scale factor images prepared by linking a plurality of divided images created through the objective lens of 100 magnifications and reducing resolutions. In other words, the virtual slides 50 can be created by any method. The size of the virtual slide 50 of 20 magnifications (see FIG. 12) preserved in the database 21a of the server 21 is 23,500 dots by 10,000 dots, and the size of each of divided partial images 50a is 500 dots by 500 dots. In other words, the virtual slide 50 of 20 magnifications is constituted of 940 partial images 50a, as shown in FIG. 12. Numbers 1 to 940 of the partial images 50a shown in FIG. 12 are assigned for specifying the respective partial images 50a in illustration of the method of downloading the virtual slide 50.

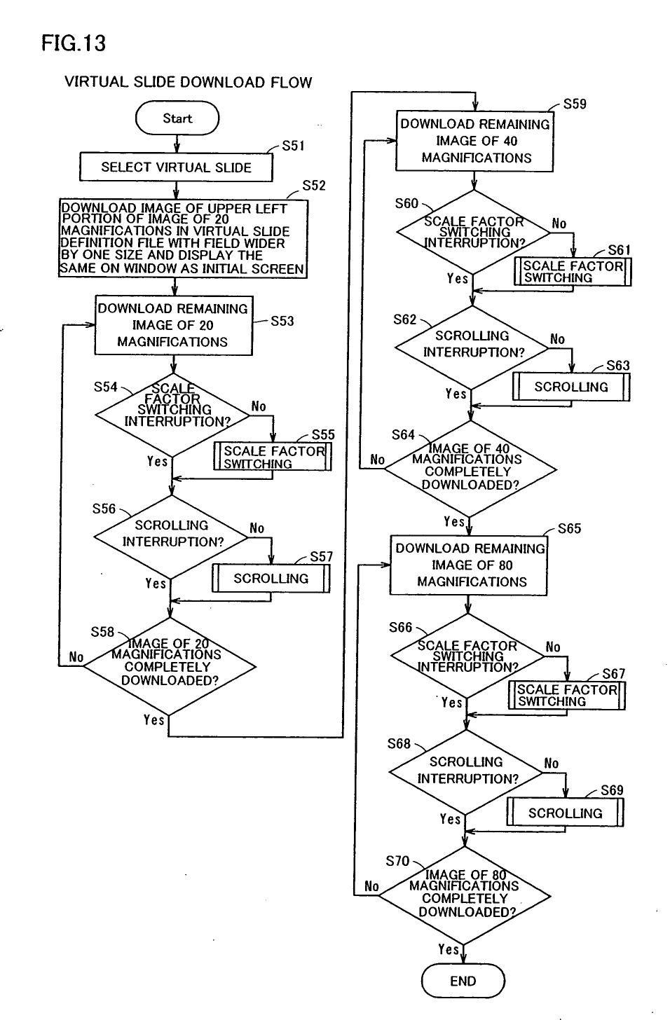

In order to download the virtual slides (blood cell images) 50 to a client terminal 31 from the server 21, the user selects the virtual slide (blood cell image) 50 to be displayed on the client terminal 31 (see FIG. 1) at a step S51 shown in FIG. 13.

According to the third embodiment, the client terminal 31 is set to display the upper left portion of the virtual slide 50 of 20 magnifications on the initial screen. Thus, the client terminal 31 downloads the partial images 50a of the upper left portion of the virtual slide 50 of 20 magnifications at a step S52. According to the third embodiment, the client terminal 31 downloads images of a range 200 one size wider than a range 100 displayed on a window of the client terminal 31, as shown in FIG. 12. The client terminal 31 displays the range 100 of the upper left portion on the window as the initial screen. The scale factor and the portion of the virtual slide 50 displayed on the window of the client terminal 31 as the initial screen can be changed by setting.

According to the third embodiment, the client terminal 31 downloads the partial images 50a constituting the virtual slide 50 of 20 magnifications preserved in the database 21a of the server 21 in previously set order as follows: First, the client terminal 31 downloads the 1^{st} to 20^{th} partial images 50a of the uppermost stage from the plurality of partial images 50a (see FIG. 12) included in the virtual slide 50 of 20 magnifications. At this time, the client terminal 31 successively downloads these partial images 50a from the leftmost 1^{st} partial image 50a toward the rightmost 20^{th} partial image 50a of the uppermost stage. Thereafter the client terminal 31 downloads the 21^{st} to 40^{th} partial images 50a of the second stage. Also at this time, the client terminal 31 successively downloads these partial images 50a from the leftmost 21^{st} partial image 50a toward the rightmost 40^{th} partial image 50a. Then, the client terminal 31 downloads the 41^{st} to 60^{th} partial images 50a of the third stage. Thus, the client terminal 31 finally downloads the rightmost 940^{th} partial image 50a, included in the 921^{st} to 940^{th} partial images 50a of the lowermost stage, thereby completely downloading all partial images 50a included in the virtual slide 50 of 20 magnifications. Thereafter the client terminal 31 downloads the partial images 50a constituting the virtual slide 50 of 40 magnifications preserved in the database 21a of the server 21 in the same order as that for downloading the partial images 50a of the virtual slide 50 of 20 magnifications. Further, the client terminal 31 downloads the partial images 50a constituting the virtual slide 50 of 80 magnifications preserved in the database 21a of the server 21 in the same order as that for downloading the partial images 50a of the virtual slide 50 of 20 magnifications.

According to the aforementioned order for downloading the partial images 50a, the client terminal 31 preferentially downloads the images of the upper left portion of the virtual slide 50 of 20 magnifications at the step S52 as “1”→“5”, “21”→“25”, “41”→“45”, “61”→“65” and “81”→“85” in the numbers of the partial images 50a shown in FIG. 12. In this case, the client terminal 31 displays the partial images 50a of the numbers “22” to “24”, “42” to “44” and “62” to “64” on the window. The client terminal 31 downloads the partial images 50a of the numbers “1” to “5”, “21”, “25”, “41”, “45”, “61”, “65” and “81” to “85” in the one-size wider range 200 to enclose the displayed range 100 without displaying the same on the window. After downloading and displaying the image of the upper left portion of the virtual slide 50 at the step S52 shown in FIG. 13, the client terminal 31 displaying the image of the upper left portion of the virtual slide 50 downloads the remaining partial images 50a constituting the virtual slide 50 of 20 magnifications in the background without displaying the same at a step S53. The client terminal 31 automatically downloads the remaining partial images 50a in the background without an instruction from the user.

The client terminal 31 preserves the partial images 50a downloaded from the server 21 in a local HDD (hard disk drive) (not shown) serving as a memory. Also at the step S53, the client terminal 31 downloads the partial images 50a along the aforementioned download order. In other words, the client terminal 31 downloads the partial images 50a in order of the numbers “6”→“20”, “26”→“40”, “46→“60”, “66”→“80”, “86”→“100”, “101”→“120”, “121”→“140”, . . . , “901”→“920” and “921”→“940” of the partial images 50a shown in FIG. 12. At a step S54 shown in FIG. 13, the client terminal 31 determines whether or not the user has made an interruption for scale factor switching during the downloading of the remaining partial images 50a constituting the virtual slide 50 of 20 magnifications. When determining that the user has made the interruption for scale factor switching during the downloading at the step S54, the client terminal 31 temporarily intermits downloading the remaining partial images 50a constituting the virtual slide 50 of 20 magnifications. Then, the client terminal 31 advances to a step S55 for switching the scale factor preferentially to the downloading of the remaining partial images 50a constituting the virtual slide 50 of 20 magnifications in the background.

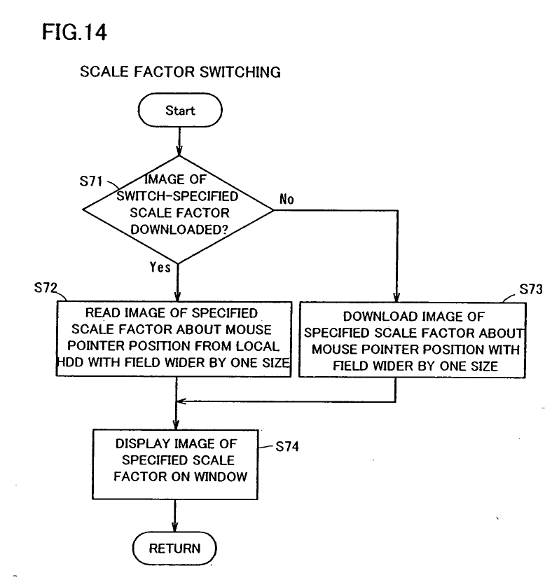

In order to switch the scale factor at the step S55, the client terminal 31 determines whether or not the same has already downloaded the partial images 50a of the virtual slide 50 of the switch-specified scale factor (40 or 80 magnifications) at a step S71 shown in FIG. 14. When determining that the same has already downloaded the partial images 50a of the virtual slide 50 of the switch-specified scale factor at the step S71, the client terminal 31 reads the partial images 50a of the virtual slide 50 of the switch-specified scale factor from the local HDD (not shown) with a one-size larger field about the position of a mouse pointer at a step S72. When determining that the same has not yet downloaded the partial images 50a of the virtual slide 50 of the switch-specified scale factor at the step S71, on the other hand, the client terminal 31 downloads the partial images 50a of the virtual slide 50 of the switch-specified scale factor with a one-size larger field about the position of the mouse pointer at a step S73. Also at the step S73, the client terminal 31 downloads the partial images 50a of the virtual slide 50 of the switch-specified scale factor (40 or 80 magnifications) along the same order as the aforementioned one for downloading the partial images 50a of the virtual slide 50 of 20 magnifications. Then, the client terminal 31 preferentially displays an upper left portion of the virtual slide 50 of the specified scale factor on the window at a step S74. Thus, the client terminal 31 terminates the scale factor switching at the step S55 (steps S71 to S74) and advances to a step S56 shown in FIG. 13.

Also when determining that the client has made no interruption for scale factor switching at the step S54 shown in FIG. 13, the client terminal 31 advances to the step S56. At the step S56, the client terminal 31 determines whether or not the user has made an interruption for scrolling. When determining that the user has made the interruption for scrolling at the step S56, the client terminal 31 temporarily intermits downloading the remaining partial images 50a constituting the virtual slide 50 of 20 magnifications. Then, the client terminal 31 advances to a step S57 for performing scrolling preferentially to the downloading of the remaining partial images 50a constituting the virtual slide 50 of 20 magnifications in the background.

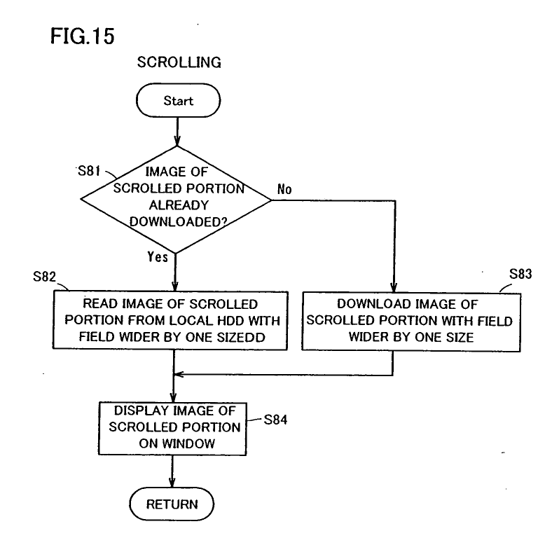

In order to perform scrolling at the step S57, the client terminal 31 determines whether or not the same has already downloaded the partial images 50a of the scrolled portion at a step S81 shown in FIG. 15. When determining that the same has already downloaded the partial images 50a of the scrolled portion at the step S81, the client terminal 31 reads the partial images 50a of the scrolled portion from the local HDD (not shown) with a one-size wider field at a step S82. When determining that the same has not yet downloaded the partial images 50a of the scrolled portion at the step S81, on the other hand, the client terminal 31 downloads the partial images 50a of the scrolled portion with a one-size wider field at a step S83. Also at the step S83, the client terminal 31 downloads the partial images 50a of the scrolled portion along the same order as the aforementioned one for downloading the partial images 50a of the virtual slide 50 of 20 magnifications. Then, the client terminal 31 preferentially displays the partial images 50a of the specified field on the window at a step S84. Thus, the client terminal 31 terminates the scrolling at the step S57 (steps S81 to S84) and advances to a step S58 shown in FIG. 13.

Also when determining that the client has made no interruption for scrolling at the step S56 shown in FIG. 13, the client terminal 31 advances to the step S58. At the step 58, the client terminal 31 determines whether or not the same has completely downloaded all partial images 50a constituting the virtual slide 50 of 20 magnifications. When determining that the same has not yet completely downloaded all partial images 50a constituting the virtual slide 50 of 20 magnifications at the step S58, the client terminal 31 returns to the step S53 for automatically downloading the remaining partial images 50a of the virtual slide 50 of 20 magnifications from the server 21 in the background. The client terminal 31 is so set as not to doubly download partial images 50a already downloaded thereto by already executed scrolling when restarting the processing of downloading the remaining partial images 50a of the virtual slide 50 of 20 magnifications in the background. The client terminal 31 re-determines whether or not the user has made an interruption for scale factor switching during the downloading of the remaining partial images 50a constituting the virtual slide 50 of 20 magnifications at the step S54.

When determining that the same has already completely downloaded all partial images 50a constituting the virtual slide 50 of 20 magnifications at the step S58, on the other hand, the client terminal 31 downloads the remaining partial images 50a constituting the virtual slide 50 of 40 magnifications from the server 21 in the background at a step S59. The client terminal 31 preserves the partial images 50a constituting the virtual slide 50 of 40 magnifications downloaded from the server 21 to the local HDD (not shown).

Also at the step S59, the client terminal 31 downloads the remaining partial images 50a constituting the virtual slide 50 of 40 magnifications along the same order as the aforementioned one for downloading the partial images 50a constituting the virtual slide 50 of 20 magnifications. The client terminal 31 is so set as not to doubly download partial images 50a already downloaded by already executed scale factor switching and scrolling when downloading the remaining partial images 50a of the virtual slide 50 of 40 magnifications in the background. The client terminal 31 determines whether or not the user has made an interruption for scale factor switching during the downloading of the remaining partial images 50a constituting the virtual slide 50 of 40 magnifications at a step S60. When determining that the user has made the interruption for scale factor switching during the downloading at the step S60, the client terminal 31 temporarily intermits downloading the remaining partial images 50a of the virtual slide 50 of 40 magnifications. Then, the client terminal 31 advances to a step S61 for performing scale factor switching similar to that described with reference to the step S55 (steps S71 to S74) preferentially to the downloading of the remaining partial images 50a of the virtual slide 50 of 40 magnifications.

When determining that the client has made no interruption for scale factor switching at the step S60, on the other hand, the client terminal determines whether or not the user has made an interruption for scrolling at a step S62. When determining that the user has made the interruption for scrolling at the step S62, the client terminal 31 temporarily intermits downloading the remaining partial images 50a of the virtual slide 50 of 40 magnifications. Then, the client terminal 31 advances to a step S63 for performing scrolling similar to that described with reference to the step S57 (steps S81 to S84) preferentially to the downloading of the remaining partial images 50a of the virtual slide 50 of 40 magnifications.

When determining that the client has made no interruption for scrolling at the step S62, on the other hand, the client terminal 31 determines whether or not the same has completely downloaded all partial images 50a constituting the virtual slide 50 of 40 magnifications at a step S64. When determining that the same has not yet completely downloaded all partial images 50a constituting the virtual slide 50 of 40 magnifications at the step S64, the client terminal 31 returns to the step S59 for automatically downloading the remaining partial images 50a constituting the virtual slide 50 of 40 magnifications from the server 21 in the background. Then, the client terminal 31 re-determines whether or not the user has made an interruption for scale factor switching during the downloading of the remaining partial images 50a constituting the virtual slide 50 of 40 magnifications at the step S60.

When determining that the same has completely downloaded all partial images 50a constituting the virtual slide 50 of 40 magnifications at the step S64, on the other hand, the client terminal 31 downloads the remaining partial images 50a constituting the virtual slide 50 of 80 magnifications from the server 21 in the background at a step S65. The client terminal 31 preserves the partial images 50a constituting the virtual slide 50 of 80 magnifications downloaded from the server 21 to the local HDD (not shown).

Also at the step S65, the client terminal 31 downloads the remaining partial images 50a constituting the virtual slide 50 of 80 magnifications along the same order as the aforementioned one for downloading the partial images 50a constituting the virtual slide 50 of 20 magnifications. The client terminal 31 is so set as not to doubly download partial images 50a already downloaded by already executed scale factor switching and scrolling when downloading the remaining partial images 50a constituting the virtual slide 50 of 80 magnifications in the background. The client terminal 31 determines whether or not the user has made an interruption for scale factor switching during the downloading of the remaining partial images 50a constituting the virtual slide 50 of 80 magnifications at a step S66. When determining that the user has made the interruption for scale factor switching during the downloading at the step S66, the client terminal 31 temporarily intermits downloading the remaining partial images 50a of the virtual slide 50 of 80 magnifications. Then, the client terminal 31 advances to a step S67 for performing scale factor switching similar to that described with reference to the step S55 (steps S71 to S74) preferentially to the downloading of the remaining partial images 50a of the virtual slide 50 of 80 magnifications.

When determining that the client has made no interruption for scale factor switching at the step S66, on the other hand, the client terminal determines whether or not the user has made an interruption for scrolling at a step S68. When determining that the user has made the interruption for scrolling at the step S68, the client terminal 31 temporarily intermits downloading the remaining partial images 50a of the virtual slide 50 of 80 magnifications. Then, the client terminal 31 advances to a step S69 for performing scrolling similar to that described with reference to the step S57 (steps S81 to S84) preferentially to the downloading of the remaining partial images 50a of the virtual slide 50 of 80 magnifications.

When determining that the client has made no interruption for scrolling at the step S68, on the other hand, the client terminal 31 determines whether or not the same has completely downloaded all partial images 50a constituting the virtual slide 50 of 80 magnifications at a step S70. When determining that the same has not yet completely downloaded all partial images 50a constituting the virtual slide 50 of 80 magnifications at the step S70, the client terminal 31 returns to the step S65 for automatically downloading the remaining partial images 50a constituting the virtual slide 50 of 80 magnifications from the server 21 in the background. Then, the client terminal 31 re-determines whether or not the user has made an interruption for scale factor switching during the downloading of the remaining partial images 50a constituting the virtual slide 50 of 80 magnifications at the step S66.

When determining that the same has completely downloaded all partial images 50a constituting the virtual slide 50 of 80 magnifications at the step S70, on the other hand, the client terminal 31 completes downloading all partial images 50a constituting the virtual slides 50 of 20, 40 and 80 magnifications from the server 21. Thus, the client terminal 31 terminates downloading the virtual slides (blood cell images) 50 from the server 21.

According to the third embodiment, as hereinabove described, the client terminal 31 is so set as to display the upper left portion of the virtual slide 50 of 20 magnifications on the initial screen when the user selects the virtual slides (blood cell images) 50 to be displayed on the client terminal 31, whereby the same can display the upper left portion of the virtual slide 50 of 20 magnifications on the window before downloading all partial images 50a constituting the virtual slides 50. Thus, the time required for displaying the upper left portion of the virtual slide 50 of 20 magnifications on the window of the client terminal 31 can be reduced as compared with a case of downloading all partial images 50a to the client terminal 31 and thereafter displaying the upper left portion of the virtual slide 50 of 20 magnifications on the window of the client terminal 31.

According to the third embodiment, the client terminal 31 preferentially downloads the partial images 50a required for display from the server 21 and displays the same when the same has not yet downloaded the partial images 50a required for display following scale factor changing and scrolling performed therein so that the partial images 50a required for display following scale factor changing and scrolling can be quickly displayed on the window of the client terminal 31.

According to the third embodiment, the client terminal 31 automatically restarts the temporarily intermitted processing of downloading the partial images 50a constituting the virtual slide 50 for the processing of preferentially downloading the partial images 50a required for display following scale factor changing and scrolling performed in the client terminal 31 so that the user may not restart the processing of downloading the partial images 50a constituting the virtual slide 50 to the client terminal 31 from the server 21, whereby the burden on the user can be reduced.

According to the third embodiment, the client terminal 31 stores the partial images 50a downloaded from the server 21 in the local HDD (hard disk drive) so that the partial images 50a once stored in the local HDD of the client terminal 31 may not be downloaded from the server 21 again for display, whereby the time for displaying the partial images 50a on the window of the client terminal 31 can be further reduced.

According to the third embodiment, the client terminal 31 reads the partial images 50a required for display following scale factor changing and scrolling performed in the client terminal 31 from the local HDD and displays the partial images 50a when the client terminal 31 has already downloaded the partial images 50a required for display from the server 21 and preserved the same in the local HDD, whereby the client terminal 31 can more quickly display the partial images 50a required for display following scale factor changing and scrolling performed in the client terminal 31 on the window thereof.

Although the present invention has been described and illustrated in detail, it is clearly understood that the same is by way of illustration and example only and is not to be taken by way of limitation, the spirit and scope of the present invention being limited only by the terms of the appended claims.

For example, while the present invention is applied to a method of displaying a blood cell image or cerebrospinal fluid cell images in each of the aforementioned embodiments, the present invention is not restricted to this but is also applicable to a method of displaying smear images other than the blood cell image or the cerebrospinal fluid cell images. In particular, the present invention is effective when display of high scale factor smear images of about 100 magnifications is necessary, for example.

While the network is constituted by connecting the automatic stage control terminal 16, the server 21 and the client terminal 31 to the LAN cable 4 in the structure shown in FIG. 1 in the aforementioned first embodiment, the present invention is not restricted to this but the Internet line may alternatively be employed in place of the LAN cable 4.

While the automatic stage control terminal 16 performs focus synthesis and image tiling and thereafter preserves the created virtual slide in the server 21 in the aforementioned first embodiment, the present invention is not restricted to this but the automatic stage control terminal 16 may perform focus synthesis and thereafter preserve the focus-synthesized image in the server 21 so that the server 21 performs image tiling thereby creating a virtual slide.

While the virtual slides 50 of three scale factors of 20, 40 and 80 magnifications are employed in the aforementioned third embodiment, the present invention is not restricted to this but images of a plurality of scale factors among those of 20, 40, 60, 80 and 100 magnifications may alternatively be employed as virtual slides.

While the client terminal 31 displays the upper left portion of the virtual slide 50 on the window as the initial screen when the user selects the virtual slides 50 in the aforementioned third embodiment, the present invention is not restricted to this but the client terminal 31 may alternatively display a portion, such as the central portion, for example, of the virtual slide 50 other than the upper left portion as the initial screen when the user selects the virtual slides 50.

While the client terminal 31 successively downloads the partial images 50a from the leftmost 1^{st} partial image 50a toward the rightmost 20^{th} partial image 50a as the order for downloading the partial images 50a from the server 21 in the aforementioned third embodiment, the present invention is not restricted to this but the client terminal 31 may alternatively successively download the partial images 50a downward from the leftmost partial image 50a of the uppermost stage as the order for downloading the partial images 50a from the server 21, for example.

1. A method of displaying a smear image in a terminal receiving said smear image taken with a scale factor allowing recognition of a cell form from an image server including a first database storing said smear image through a communication network and displaying said smear image, comprising steps of:
acquiring a prescribed partial image necessary for display, included in a plurality of partial images obtained by dividing said smear image and stored in said first database of said image server, from said image server through said communication network and displaying said prescribed partial image; and
acquiring another said partial image required for display due to display scrolling on said terminal from said image server through said communication network and displaying said partial image in response to said display scrolling.

2. The method of displaying a smear image according to claim 1, wherein
said smear image displayed on said terminal is an image obtained by image-tiling partial area images prepared by taking images of respective areas of a sample with a scale factor allowing recognition of a cell form to partially overlap with adjacent said areas.

3. The method of displaying a smear image according to claim 2, wherein
each said partial area image is an image obtained by focus-synthesizing a plurality of images taken on different focal positions as to a substantially identical area.

4. The method of displaying a smear image according to claim 1, wherein
said step of acquiring said prescribed partial image necessary for display from said image server through said communication network and displaying said prescribed partial image includes a step of acquiring a partial image of a wider area than said partial image displayed on said terminal from said image server through said communication network.

5. The method of displaying a smear image according to claim 1, wherein
said step of acquiring said partial image required for display due to said display scrolling from said image server through said communication network and displaying said partial image includes a step of acquiring a partial image of a wider area than said partial image displayed on said terminal due to said display scrolling from said image server through said communication network.

6. The method of displaying a smear image according to claim 1, wherein
said terminal displays said smear image to be zoomable to an arbitrary scale factor.

7. The method of displaying a smear image according to claim 1, wherein
said smear image is a blood smear image.

8. A smear image display program for executing a method of displaying a smear image taken with a scale factor allowing recognition of a cell form in a terminal receiving said smear image from an image server including a first database recording said smear image through a communication network and displaying said smear image, said method comprising steps of:
acquiring a prescribed partial image necessary for display, included in a plurality of partial images obtained by dividing said smear image and stored in said first database of said image server, from said image server through said communication network and displaying said prescribed partial image and acquiring another said partial image required for display due to display scrolling on said terminal from said image server through said communication network and displaying said partial image in response to said display scrolling.

9. A machine-readable recording medium recording a smear image display program for executing a method of displaying a smear image taken with a scale factor allowing recognition of a cell form in a terminal receiving said smear image from an image server including a first database recording said smear image through a communication network and displaying said smear image, said method comprising steps of:
acquiring a prescribed partial image necessary for display, included in a plurality of partial images obtained by dividing said smear image and stored in said first database of said image server, from said image server through said communication network and displaying said prescribed partial image and acquiring another said partial image required for display due to display scrolling on said terminal from said image server through said communication network and displaying said partial image in response to said display scrolling.

10. A method of sort-counting a cell on a screen displayed by a method of displaying a smear image comprising steps of acquiring a prescribed partial image necessary for display, included in a plurality of partial images obtained by dividing said smear image and stored in a first database of an image server, from said image server through a communication network and displaying said prescribed partial image and acquiring another said partial image required for display due to display scrolling on a terminal from said image server through said communication network and displaying said partial image in response to said display scrolling, comprising steps of:
displaying a display screen including an image display part scrollably displaying said smear image received from said image server and a sort count display part for displaying a sort count value obtained by counting sort data of said cell; and
inputting said sort data by scrolling and observing said smear image displayed on said image display part.

11. The method of sort-counting a cell according to claim 10, further comprising steps of:
instructing capture of said smear image displayed on said image display part, and
recording said smear image displayed on said image display part and attribute information of a specimen employed for creating said smear image in a second database through said communication network on the basis of said instruction for capturing said smear image.

12. The method of sort-counting a cell according to claim 11, wherein
said step of instructing capture of said smear image includes a step of instructing capture of said smear image in response to entry of said sort data.

13. A method of retrieving a smear image performed on a screen displayed by a method of displaying a smear image comprising steps of acquiring a prescribed partial image necessary for display, included in a plurality of partial images obtained by dividing said smear image and stored in a first database of an image server, from said image server through a communication network and displaying said prescribed partial image and acquiring another said partial image required for display due to display scrolling on a terminal from said image server through said communication network and displaying said partial image in response to said display scrolling, said image server storing said smear image along with retrieval conditions, comprising steps of:
displaying a list of said smear image matching with said retrieval conditions in response to a retrieval result on said terminal as said retrieval result from said image server through said communication network; and
scrollably displaying selected said smear image in response to an operation of selecting prescribed said smear image in said list.

14. A surveillance method for a smear image performed on a screen displayed by a method of displaying a smear image comprising steps of acquiring a prescribed partial image necessary for display, included in a plurality of partial images obtained by dividing said smear image and stored in a first database of an image server, from said image server through a communication network and displaying said prescribed partial image and acquiring another said partial image required for display due to display scrolling on a terminal from said image server through said communication network and displaying said partial image in response to said display scrolling, comprising steps of:
displaying said smear image and a question related to said smear image on a specific web;
receiving an answer to said question through said communication network;
displaying a tabulation result of said answer on said web; and
scrollably displaying selected said smear image on said terminal in response to an operation of selecting said smear image displayed on said web.

15. A system of displaying a smear image in a terminal receiving said smear image taken with a scale factor allowing recognition of a cell form from an image server including a first database storing said smear image through a communication network and displaying said smear image, comprising:
first display means acquiring a prescribed partial image necessary for display, included in a plurality of partial images obtained by dividing said smear image and stored in said first database of said image server, from said image server through said communication network and displaying said prescribed partial image; and
second display means acquiring another said partial image required for display due to display scrolling on said terminal from said image server through said communication network and displaying said partial image in response to said display scrolling.

16. A method of displaying a smear image in a terminal receiving said smear image taken with a scale factor allowing recognition of a cell form from an image server including a first database storing said smear image through a communication network and displaying said smear image, comprising steps of:
acquiring a plurality of partial images, obtained by dividing said smear image and stored in said first database of said image server, from said image server through said communication network in prescribed order and displaying prescribed said partial image, necessary for display, included in acquired said partial images; and
preferentially acquiring another said partial image required for display due to an operation for display on said terminal from said image server through said communication network and displaying said partial image in response to said operation when said partial image required for display is not acquired from said image server.

17. The method of displaying a smear image according to claim 16, wherein
said operation for display on said terminal is scrolling.

18. The method of displaying a smear image according to claim 16, wherein
said operation for display on said terminal is scale factor changing.

19. The method of displaying a smear image according to claim 16, restarting processing of acquiring said partial images from said image server in said prescribed order after preferentially acquiring said partial image required for display due to said operation from said image server.

20. The method of displaying a smear image according to claim 16, storing said partial images acquired from said image server in a memory of said terminal.

21. The method of displaying a smear image according to claim 20, reading said partial image required for display from said memory of said terminal when acquiring said partial image required for display due to said operation from said image server and preserving said partial image in said memory of said terminal in response to said operation for display on said terminal.

22. The method of displaying a smear image according to claim 18, wherein
said first database stores a plurality of first partial images obtained by dividing a first smear image taken with a first scale factor and a plurality of second partial images obtained by dividing a second smear image taken with a second scale factor,
said method acquiring said first partial images from said image server through said communication network in said prescribed order for displaying prescribed said first partial image, necessary for display, included in acquired said first partial images, and
preferentially acquiring said second partial image required for display due to said scale factor changing from said image server through said communication network and displaying said second partial image in response to said scale factor changing of display on said terminal.

23. The method of displaying a smear image according to claim 16, wherein
said step of acquiring said plurality of partial images, obtained by dividing said smear image and stored in said first database of said image server, from said image server through said communication network in said prescribed order and displaying prescribed said partial image, necessary for display, included in acquired said partial images includes a step of acquiring a partial image of a wider area than said partial image displayed on said terminal from said image server through said communication network.

24. The method of displaying a smear image according to claim 16, wherein
said step of preferentially acquiring another said partial image required for display due to said operation for display on said terminal from said image server through said communication network and displaying said partial image in response to said operation when said partial image required for display is not acquired from said image server includes a step of acquiring a partial image of a wider area than said partial image required for display from said image server through said communication network in response to said operation for display on said terminal.

25. A system of displaying a smear image in a terminal receiving said smear image taken with a scale factor allowing recognition of a cell form from an image server including a first database storing said smear image through a communication network and displaying said smear image, comprising:
first display means acquiring a plurality of partial images, obtained by dividing said smear image and stored in said first database of said image server, from said image server through said communication network in prescribed order and displaying prescribed said partial image, necessary for display, included in acquired said partial images; and
second display means preferentially acquiring said partial image required for display due to an operation for display on said terminal in response to said operation from said image server through said communication network and displaying said partial image when said partial image required for display is not acquired from said image server.
